(19) United States
(12) Patent Application Publication
(10) Pub. No.: US 2004/0220997 A1
(43) Pub. Date: Nov. 4, 2004

(54) Mobile wireless data transfer, storage, retrieval, and delivery system for remote printing and sorting of mail

(76) Inventor: Jeffery De Saint-Johns, Aspen, CO (US)

Correspondence Address: JEFFERY DE SAINT-JOHNS, BOX 123, ASPEN, CO, 81612, US

(21) Appl. No.: 10/427,628

(22) Filed: Apr. 30, 2003

(51) Int. Cl. G06F 15/16

(52) U.S. Cl. 709/201

(57) ABSTRACT

A method and system for remote printing and sorting of an electronic document in hard copy form for use in a system in which a sender of the electronic document operates a computer to access at least one server via a communications network to send the document to a recipient is provided. The method includes sending an electronic document to a server via a communications network, wherein the document includes a destination identifier for the recipient of the document; receiving the electronic document by at least one server, sorting the document based upon the destination identifier of the recipient of the document; routing said document to one of a plurality of remote mail delivery systems based upon the destination identifier; and generating a hard copy of the document by the remote mail delivery system.

### BACKGROUND OF THE INVENTION

1. Field of the Invention

The invention relates to a computer implemented system and method for remote printing and sorting of mail.

2. Description of Related Technology

Electronic mail, the electronic equivalent of paper based letters and memoranda, is a widely used means of written communication. Its primary advantages over other forms of written communication are its short delivery time and its low cost. These two factors contribute greatly to electronic mail's current popularity.

In order to receive and/or transmit electronic mail using such resources, electronic mail systems allow one user to send messages and documents by electronic transmission to mailboxes of other users. In general, the electronic mail is stored in an electronic virtual mailbox, contained on a host computer. The virtual mailbox can be a memory location or a disk storage area on a host computer. The host computer can be operated by electronic mail providers. Most users access their electronic mail from their personal computer, whether it is located at their office, for corporate users, or at their residence, for personal users. However, when the user is away from their personal computer, it is often difficult to retrieve electronic mail from their mailbox absent the use of, for example, a Palm Pilot™ or equivalent. One solution would be for the user to have a laptop or a portable computer with them at all times to facilitate accessing electronic mail when away from their personal computers. Unfortunately, it is not practical for many people to have a laptop or personal computer with them at all times solely for retrieving their electronic mail.

Another solution would be for electronic mail providers to have remotely located user-interface devices. In this way, users that subscribe to a particular electronic mail provider can access electronic mail from these remotely located user-interface devices.

A disadvantage of these user-interface devices is that they are source dependent in that a user-interface device which has been configured and has the formatting and protocol information for accessing electronic mail from one electronic mail provider cannot access electronic mail from host computers of other electronic mail providers. It is not cost-effective to configure and provide formatting, protocol and configuration information at each user-interface device for accessing mailboxes contained on two or more host computers. This problem is compounded when the large number of private organizations having internal electronic mail systems for their employees is considered.

Furthermore, there is limited space at the user-interface devices on which to store formatting, protocol, and configuration information to access mailboxes contained on each of the different host computers. In addition, there are potential incapability problems between the various mail systems, which could prevent one user-interface device having the ability to access electronic mail from a plurality of host computers.

Moreover, some user-interface devices, such as telephones having electronic mail capability, simply do not have the storage space to store the information necessary to receive electronic mail stored in mailboxes contained on a plurality of host computers.

Communications via electronic mail resources are becoming more and more common. However, while electronic mail is usually a faster way of transmitting documents, many people still prefer paper, which offers the simplest, most foolproof way of communicating. Furthermore, many people are precluded from participating in electronic communication because they do not have personal computers. Under current electronic mail systems, the recipient of an electronic mail message must have access to a personal computer to retrieve electronic mail.

### SUMMARY OF THE INVENTION

The disclosed invention includes a method and apparatus for transferring electronic mail or other data into a printed mail type format suitable for hand delivery.

In one aspect of the invention, interface and software code for transferring the data from an Internet server to the desired location is provided. Advantageously, encryption software is likewise provided to ensure that transferred information from a server to a remote mail delivery system cannot be read by a third party.

In another aspect of the invention, there is provided a method for remote printing and sorting of an electronic document for use in a system in which a sender of the electronic document operates a computer to access at least one server via a communications network to send said document to a remote location. Preferably, the method includes sending an electronic document to a server via a communications network, wherein the document includes a destination identifier for the recipient of the document; receiving the electronic document by at least one server; sorting the document based upon the destination identifier of the recipient of the document; routing the document to one of a plurality of remote mobile mail systems based upon the destination identifier; and providing a hard copy of the document by the remote mobile mail system. Optionally, the method additionally includes the step of packaging the electronic document in tangible form. Preferably, the electronic document is encrypted prior to routing the document to one of a plurality of remote mobile mail systems.

In another aspect of the invention, receiving the electronic document includes receiving information from the sender through a web-based interface.

In yet another aspect of the invention, the electronic document is selected from the group consisting of electronic mail, advertisements, digital images, photographs, direct mailings, postcards, checks, music, or video.

A mobile mail delivery system capable of receiving an electronic document over a computer network from a remote location, printing and packaging the electronic document in tangible, hard copy form for delivery to an intended recipient is similarly provided. The system includes an electronic document module configured to receive an electronic document from a computer operated by a sender to a mobile mail system via a communications network; an electronic document storage configured to store one or more electronic documents; an encryption module configured to encode the document; a destination identifier module configured to correlate the desired destination of the electronic document with the locations of mobile mail systems; a destination identifier storage configured to store information regarding the location of one or more mobile mail systems, a mobile mail system routing module configured to access electronic documents stored in the electronic document storage and to search the destination identifier storage to find mobile mail systems located in close proximity to the sender's recipient.

### BRIEF DESCRIPTION OF THE DRAWINGS

FIG. 1 is a block diagram illustrating components of a remote printing and sorting system in accordance with one embodiment of the invention.

FIG. 2 is a diagram illustrating components of a mobile delivery, data storage, and sending unit in accordance with one embodiment of the invention.

FIG. 3 is a representation of a system server.

### DETAILED DESCRIPTION OF THE PREFERRED EMBODIMENT

Embodiments of the invention will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

Aspects of the present invention permit communication between a community of mail senders and mail recipients, across a computer network, such as the Internet, as generally understood in the art. As used herein, “Internet” refers to a network or combination of networks spanning any geographical area, such as a local area network, wide area network, regional network, national network, and/or global network. As used herein, “Internet” may refer to hardwire networks, wireless networks, or a combination of hardwire and wireless networks. Hardwire networks may include, for example, fiber optic lines, cable lines, ISDN lines, copper lines, etc. Wireless networks may include, for example, cellular systems, personal communication services (PCS) systems, satellite communication systems, packet radio systems, and mobile broadband systems. A cellular system may use, for example, code division multiple access (CDMA), time division multiple access (TDMA), personal digital phone (PDC), Global System Mobile (GSM), or frequency division multiple access (FDMA), among others.

The system of the present invention can include a website wherein mail senders and mail recipients can make use of the features of the present invention, as described herein. As used herein, the term “website” refers to one or more interrelated web page files and other files and programs on one or more web servers, the files and programs being accessible over a computer network, such as the Internet, by sending a hypertext transfer protocol (http) request specifying a uniform resource locator (URL) that identifies the location of one of said web page files, wherein the files and programs are owned, managed or authorized by a single business entity. Such files and programs can include, for example, hypertext markup language (HTML) files, common gateway interface (CGI) files, and Java applications. The web page files preferably include a home page file that corresponds to a home page of the website. The home page can serve as a gateway or access point to the remaining files and programs contained within the website. In one embodiment, all of the files and programs are located under, and accessible within, the same network domain as the home page file. Alternatively, the files and programs can be located and accessible through several different network domains.

In one embodiment, the website includes a plurality of web pages, such as the above-mentioned home page. As used herein, a “web page” comprises that which is presented by a standard web browser in response to an http request specifying the URL by which the web page file is identified. A web page can include, for example, text, images, sound, video, and animation. As used herein, with reference to a particular website, an “internal web page” refers to a web page that is part of that website. Thus, an internal web page is a web page that is owned, managed, or authorized by the same entity that owns or manages the website. An internal web page can be located either within or outside of the same network domain or path as the home page file of the website.

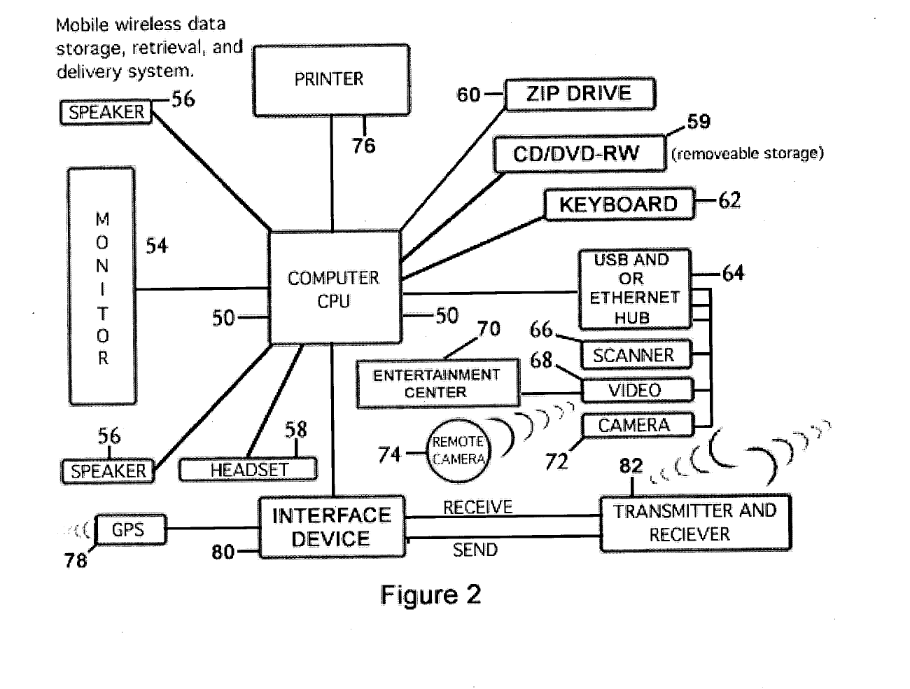

As used herein, a “sender” refers to a person or persons that use the website of the present invention for the purposes of sending electronic mail to a remote mobile mail system. The term “electronic mail” is used interchangeably with “electronic document” and includes, without limitation, any data exchanged over the internet such as digital or electronic documents, videos, postcards, photographs, scanned images, advertisements, direct mailings, checks, bills, music, VHS videotapes or High 8 videotapes. A “mobile mail system”, as used herein, includes a mobile, wireless data storage, retrieval, and delivery system comprising at least one monitor, a keyboard, a CDRW and/or DVD-RW (read and write) combo drive, at least one operating CPU, a printer, and a system for wireless and/or hardwire communication between the remote mobile mail system and a server. As will be described in greater detail with reference to FIG. 2, the mobile mail system is in wireless communication with the website of the present invention. The mobile mail system is configured to encode, sort, and print a hard copy of electronic mail. “Hard copy”, as used herein, refers to the actual, physical copy of the electronic document fixed in a tangible medium of expression. For example, the “hard copy” of an electronic document can be the printed, paper version of a document, postcard, bill, direct mailing, check, or other mail item. Additionally, the term “hard copy” encompasses electronic data that has been burned onto a CD, transferred onto a VHS or High 8 videotape, or DVD.

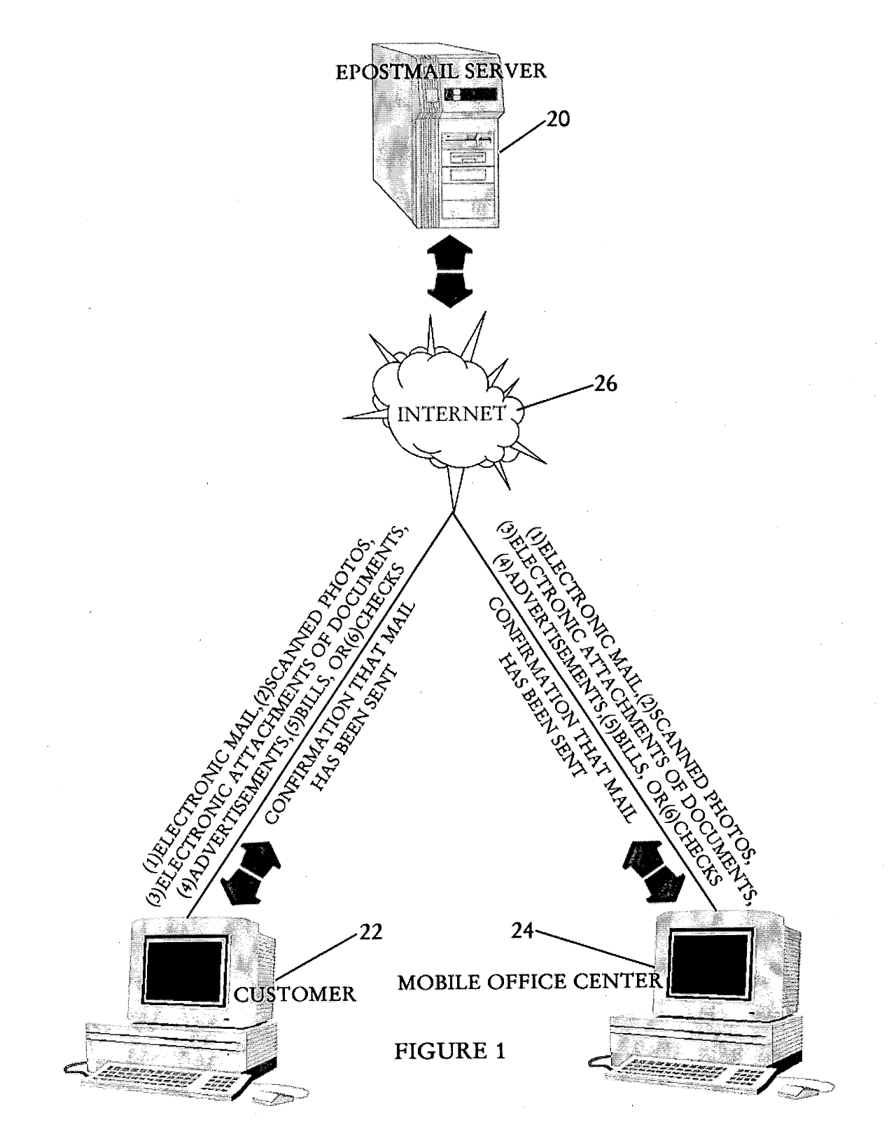

FIG. 1 shows one embodiment of a system having features in accordance with the teachings of the present invention. The system preferably includes an electronic postmail web server 20, described in greater detail below. Although only one server 20 is shown, those of ordinary skill in the art will readily appreciate from the teachings herein that any number of servers 20 can be provided. The server 20 is connected to the Internet 26. Also connected to the Internet 26 is a plurality of user computers used by senders, such as the illustrated sender 22. At least one mobile mail system 24 is likewise connected to the Internet 26. While only one mobile mail system 24 is illustrated, it will be appreciated that a plurality of mobile mail systems can be in communication with the electronic post mail web server 20. The sender 22 can communicate with a mobile mail system and access the server 20 across the Internet 26.

The web server 20 is comprised of one or more computers as defined herein. A computer, including the user computers and the computers comprising the web server 20, may be any microprocessor or processor controlled device that permits access to the Internet 26, including terminal devices, such as personal computers, workstations, servers, clients, mini computers, main-frame computers, laptop computers, a network of individual computers, mobile computers, palm-top computers, hand-held computers, set top boxes for a TV, interactive televisions, interactive kiosks, personal digital assistants, interactive wireless communications devices, mobile browsers, or a combination thereof. The computers may further possess input devices such as a keyboard, mouse, touchpad, joystick, pen-input-pad, and output devices such as a computer screen and a speaker.

These computers may be uni-processor or multi-processor machines. Additionally, these computers include an addressable storage medium or computer accessible medium, such as random access memory (RAM), an electronically erasable programmable read-only memory (EEPROM), programmable read-only memory (PROM), erasable programmable read-only memory (EPROM), hard disks, floppy disks, laser disk players, digital video devices, compact disks, video tapes, audio tapes, magnetic recording tracks, electronic networks, and other techniques to transmit or store electronic content such as, by way of example, programs and data. In one embodiment, the computers are equipped with a network communication device such a network interface card, a modem, or other network connection device suitable for connecting to a networked communication medium.

Furthermore, the computers execute an appropriate operating system such as Linux, Unix, Microsoft® Windows®, Apple® MacOS®, or IBM® OS/2®. As is conventional, the appropriate operating system includes a communications protocol implementation which handles all incoming and outgoing message traffic passed over the Internet 26. In other embodiments, while the operating system may differ depending on the type of computer, the operating system will continue to provide the appropriate communications protocols necessary to establish communication links with the Internet 26.

The computers may advantageously contain program logic, or other substrate configuration representing data and instructions, which cause the computer to operate in a specific and predefined manner as described herein. In one embodiment, the program logic may advantageously be implemented as one or more modules. The modules may advantageously be configured to reside on the addressable storage medium and configured to execute on one or more processors. The modules include, but are not limited to, software or hardware components, which perform certain tasks. Thus, a module may include, by way of example, components, such as, software components, object-oriented software components, class components and task components, processes, functions, attributes, procedures, subroutines, segments of program code, drivers, firmware, microcode, circuitry, data, databases, data structures, tables, arrays, and variables.

Referring to FIG. 1, the sender 22 can send various items of information to the server 20. In the illustrated embodiment, the sender 22 can send, for example, (1) electronic mail, (2) scanned photographs, (3) electronic attachments of documents, (4) advertisements, (5) bills, and (6) checks. As will be described in greater detail with reference to FIG. 2, the sender 22 (as seen in FIG. 1) can receive various items of information from the mobile mail system 24 (as seen in FIG. 1) such as confirmation that the mail was sent and the timing of the delivery of the mail to the intended recipient. Those of ordinary skill in the art will readily appreciate from the teachings herein that various other items of information can be sent and received by the sender 22.

In some embodiments, a method for remotely printing and sorting of an electronic document in hardcopy form is provided. The sender of electronic data accesses at least one server via a communications network. Letters, images, documents, movies, videos, checks, bills, advertisements, music or other data are sent in electronic form to at least one server. Additionally, the sender inputs a destination identifier such as the zip code of the recipient of the electronic data (to be delivered) in hardcopy form. The server correlates the destination identifier with the geographic location of at least one mobile mail system.

In one aspect of the invention, a method of remote printing of electronic checks over the internet to at least one mobile mail system is provided. The sender of the electronic check accesses at least one server via a communications network and sends a request to generate at least one check to the server. Preferably, the sender provides a copy of the sender's signature either by facsimile or similar method and the signature is stored on the server as a digital image. Once the sender requests the printing and delivery of a check, the server imports the digital signature into the electronic check and routes the check with digital signature to at least one mobile mail system. Thus, the mobile mail system is adapted to generate the digital signature of the sender on the printed check.

FIG. 2 is an illustration of one embodiment of the mobile mail system 24 of the disclosed invention. The mobile mail system 24 is a mobile wireless data storage, retrieval, and delivery system. In some remote configurations, the mobile mail system 24 may also utilize hardwire connectivity. The mobile mail system 24 includes a computer 50 as described with reference to FIG. 1 in communication with the electronic post mail web server 20. The computer 50 is similarly in communication with display components. As illustrated, the computer 50 is operatively connected to a monitor 54. Additional optional components in communication with the computer 50 include speakers 56 and a headset 58.

The mobile mail system 24 advantageously includes a removable storage device such as a CDRW-DVDRW 59 and/or a zip drive 60 in communication with the computer 50. A keyboard 62 provides a user the ability to input data into the computer 50. Additional features may include, without limitation, a usb and/or ethernet hub 64, a scanner 66, a video card 68 in communication with an entertainment center 70, a digital camera 72, a printer 76, a GPS location device 78, an interface device 80 for connecting the GPS and/or the wireless signal transmitting and receiving device 82 with the Computer CPU 50, or combinations thereof. Advantageously, a remote camera 74 is also included in the mobile mail system. In one embodiment of the invention, the remote camera 74 is utilized in concert with software programs such as Quick Time© to record movies onto DVD, VCR compatible videotape such as VHS, High 8 videotape for use with a camcorder, or CD.

Still with reference to FIG. 2, a self-initialized printer 76 is in communication with the computer 50. When the computer 50 receives data from the server 20, the data is processed and printed on the printer 76. Advantageously, the printer 76 is configured to generate checks and documents and to print, fold, and seal those documents, forms, or letters. In one embodiment, the printer 76 includes a removable device that attaches to the printer and prints, folds, and seals forms and documents.

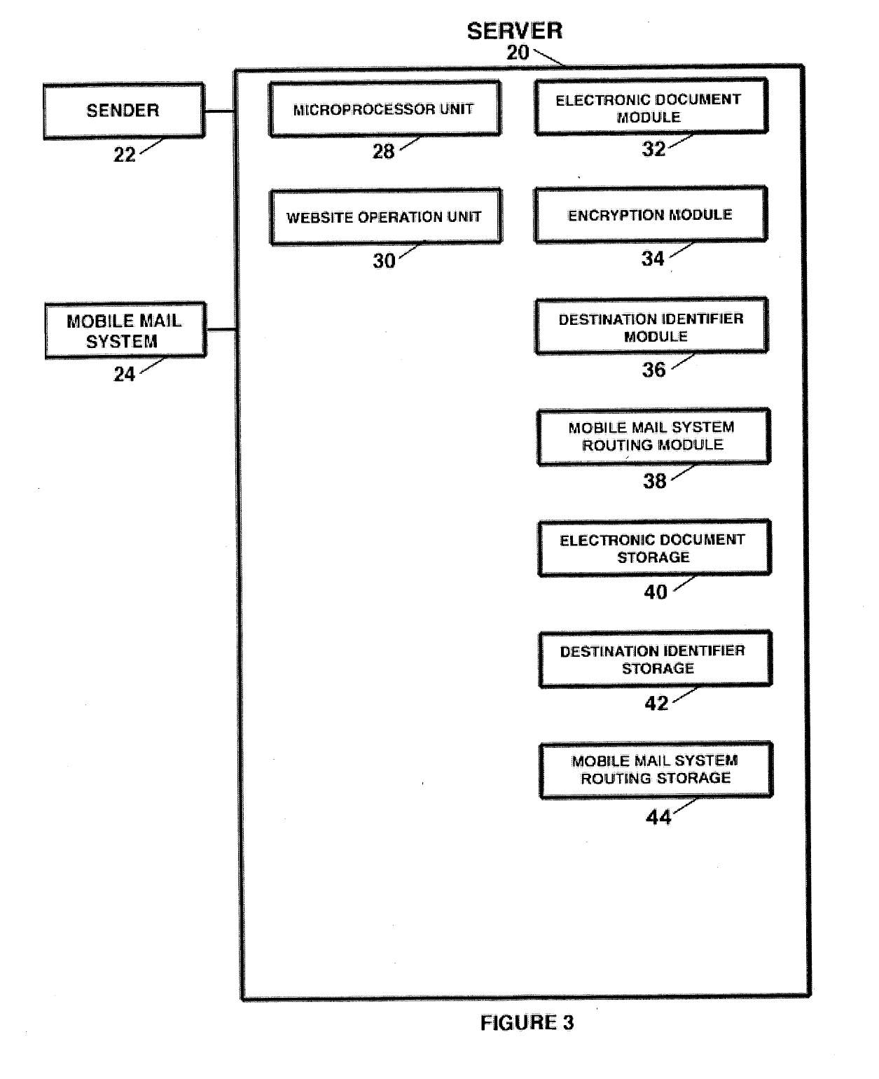

FIG. 3 represents one embodiment of a server 20 according to the present invention. The server 20 may comprise any combination of several different components, including a microprocessor unit 28, a Website Operation Unit 30, an Electronic Document Module 32, an Encoding/Encryption Module 34, a Destination Identifier Module 36, a Mobile Mail System Routing Module 38, an Electronic Document Storage 40, a Destination Identifier Storage 42, and a Mobile Mail System Routing Storage 44 as described herein. Some of the components illustrated in FIG. 3 can be integrated or overlapped. In some embodiments, the server 20 can comprise other components instead of or in addition to the components shown in FIG. 3. In other embodiments, the server 20 can comprise less than all of the components shown in FIG. 3. The words “unit,” “module,” and “component,” as used herein, can refer to software, hardware, or a combination of software and hardware.

The components depicted in FIG. 3 may advantageously communicate with each other and other components comprising the respective mobile mail system through mechanisms such as, by way of example, interprocess communication, remote procedure call, and other various program interfaces. The components may advantageously be implemented to execute on one or more computers. In some embodiments, some of the components may be implemented to execute on one or more computers external to the web server(s) 20. In this instance, the server 20 includes program logic that enables the server 20 to communicate with the externally implemented components to perform the functions as disclosed herein.

The server 20 can include a memory unit configured to store the various data and software and firmware modules described herein. The memory unit may comprise a nonvolatile memory, such as, for example, a semiconductor chip or a hard drive. The memory unit may further comprise a random access memory, a memory buffer, and/or a back-up memory.

The microprocessor unit 28 can comprise one or more microprocessors and/or microcontrollers. The microprocessor unit 28 is configured to process data and commands stored in the memory unit. In particular, the microprocessor unit 28 is configured to operate the software and hardware modules described herein.

The Website Operation Unit 30 includes data files and programs used for providing and operating an Internet website configured according to the present invention. The Website Operation Unit 30 can comprise, for example, HTML files, CGI files, Java applications, etc. In addition, the other components of the server 20 can also include such files.

The Electronic Document Module 32 is configured to assist a sender, such as the illustrated sender 22, in directing electronic data to a remote location for printing the data in hardcopy form. In other words, the sender 22 can interact with the Electronic Document Module 32 to generate and send the sender's electronic data to the server 20. Advantageously, the electronic data comprises information such as a digital image, document, or similar. The server 20, in turn, routes the electronic data to a particular mobile mail system based upon the destination identifier. For example, in one embodiment, the destination identifier corresponds with the zip code of the intended recipient. When the sender inputs the zip code of the recipient, the server correlates the zip code with the location of a mobile mail delivery system in close geographic proximity to the corresponding zip code.

The module 32 can be configured to intelligently query the sender in order to obtain sufficient information to search for and identify a mobile mail unit location in close proximity to the desired destination of the sender's electronic information.

The Electronic Document Module 32 can obtain the information that comprises the sender's instructions regarding the destination and packaging of the sender's electronic mail by different methods. In one embodiment, a series of drop-down menus is provided, whereby the sender 22 selects among descriptive options. For example, a first drop-down menu can provide a selection of printing a one page, electronic post mail express document; a check with digital signature; or a document with multiple pages. A second drop-down menu can provide a selection of media on which to produce the desired document or image such as, for example, CD, video, or paper form. In this manner, the sender 22 can provide information within each of various information fields or areas. Other web-based information retrieval methods can also be used. For example, the sender 22 can manually input information within a dialog box configured to receive a string of characters typed in from the sender's computer keyboard. Similarly, information can be submitted by selecting from a list of hyperlink options with the use of a mouse. As used herein, a “hyperlink” may comprise a text link, an image link, or other known types of links. Pop-up menus can also be provided. Those of ordinary skill in the art will readily appreciate from the teachings herein that any combination of these and other well known web-based information querying and reception methods can be used to receive the customer's commission requests.

The Electronic Document Module 32 can also be configured to allow the sender 22 to upload photos, digital pictures, scanned documents, or similar images to the server 20. The module 32 can further be configured to allow the sender 22 to upload media files, such as graphics, audio, video, or animation files, to the server 22. Such media files can comprise graphic or physical demonstrations, music, digital movies, oral messages, etc. For example, a sender can upload images from his or her home computer, such as images created with application programs such as Adobe Illustrator™, Paint Shop Pro™, and Corel Photo-Paint™. In one embodiment, the module 32 is configured to store the sender's electronic mail, along with any associated information, data, or media files, in the electronic document storage 40 in any of various formats, depending upon their content, including AIFF (Audio Interchange File Format), AU (Ulaw audio file), AVI (Video for Windows), Binhex (Macintosh file format), BMP (Bitmap), DWG (AutoCAD drawing file), DXF (Drawing eXchange Format), EPS (Encapsulated PostScript), GIF (color image format), HTML (HyperText Markup Language), JPEG (Joint Photographic Experts Group), MAX (Studio Max file format), MIDI (music format), MPEG (Moving Picture Experts Group), PSD (PhotoShop image), PICT (Macintosh image format), PS (PostScript), MOV (QuickTime movie), PDF (Portable Data Format), RTF (Rich Text Format), SWF (Shockwave Flash), TIFF (Tagged Image File Format), and WAV (Wave sound file). Images are preferably stored as data files created through well known image compression techniques.

In some embodiments, an Encryption Module 34 is provided. The Encryption Module 34 is configured to encode data received from the sender. Advantageously, the Encryption Module is configured to encode the data including the destination identifier so that it can only be read by the receiving printer.

The Destination Identifier Module 36 is configured to identify the location of the nearest mobile mail system for delivery of the electronic document sent by the sender and stored in the electronic document storage 40. In one embodiment, when a sender 22 enters an electronic document, the module 36 accesses the request from the storage 40 and then searches the destination identifier storage 42 to find one or more mobile mail systems located in geographic proximity to the intended recipient of the sender's document. The module 36 can be configured to compare and match the destination identifier, for example the recipient's address, with the location of the nearest mobile mail system when configured and remotely networked with that mobile system which incorporates the GPS device 78 as seen in FIG. 2. This comparison may be conducted using well known search techniques. In one embodiment, the “term frequency inverse document frequency” (TFIDF) approach is used. Algorithms for implementing this approach are well known and are commonly available in software development kits associated with commercial search engines such as AltaVista® and Excite_.

A routing system module 38 is configured to process an electronic document from the server to the appropriate mobile mail system. Advantageously, the electronic document has been encoded. After the destination identifier module 36 has correlated the destination identifier entered by the sender with the location of a mobile mail system in close proximity to the destination identifier, the routing system sorting module 38 directs the document in electronic form to one of a plurality of mobile mail systems.

The various storage modules shown in FIG. 3 can be located within the memory unit of the server 20. The electronic document storage 40 is configured to store electronic mail, digital images, etc. as described herein. The destination identifier storage 42 is configured to store the location of the mobile mail systems as described herein.

The server 20 can include a selections log that is used to create a historical database for each sender who utilizes the system. The information within this historical database can be used to enhance subsequent visits by the same sender. For example, the mailing address information received from a particular sender during one visit can be retained so that the sender does not need to reenter the information during subsequent visits. A particular sender can be identified by his or her electronic mail address, via an assigned identification code, or some combination of the two. In one embodiment, senders must register with an identification code and password during their initial visit to the website. Senders then submit this identification code and password in a login web page during subsequent visits to gain access to the remainder of the website.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A method for remote printing and sorting of an electronic document in paper form for use in a system in which a sender of the electronic document operates a computer to access at least one server via a communications network to send said document to a recipient, said method comprising:
sending an electronic document to a server via a communications network, wherein said document includes a destination identifier for the recipient of said document;
receiving said electronic document by at least one server;
sorting said document based upon the destination identifier of the recipient of said document;
routing said document to one of a plurality of remote mail delivery systems based upon the destination identifier; and
generating a hard copy of said document.

2. The method of claim 1, wherein receiving said electronic document comprises receiving information from the sender through a web-based interface.

3. The method of claim 1, wherein said electronic document is selected from the group consisting of electronic mail, forms, advertisements, digital images, photographs, direct mailings, postcards, checks, videos, or music.

4. A mobile mail delivery system capable of receiving an electronic document from a remote location, generating, and packaging said electronic document in hard copy form for delivery to an intended recipient over a computer network, said system comprising:
an electronic document module configured to receive an electronic document from a computer operated by a sender to a recipient via a communications network, wherein said electronic document includes the address of said recipient;
an electronic document storage configured to store one or more electronic documents;
a destination identifier module configured to identify the location of at least one of a plurality of mobile mail systems;
a destination identifier storage configured to store locations of said plurality of mobile mail systems;
a routing system module configured to access electronic documents stored in said electronic document storage and to search said destination identifier storage to find mobile mail units geographically located substantially close to said recipient's address; and
wherein the sender can send electronic documents from user computers via said communications network, and wherein the electronic documents are delivered to said mobile mail delivery system

5. The mobile mail delivery system of claim 4, additionally comprising an encryption module configured to encode said document.
